(19) United States
(12) Patent Application Publication
(10) Pub. No.: US 2025/0001782 A1
(43) Pub. Date: Jan. 2, 2025

(54) PRINTING DEVICE

(71) Applicant: BROTHER KOGYO KABUSHIKI KAISHA, Nagoya (JP)

(72) Inventor: Shunsuke OKAI, Obu (JP)

(21) Appl. No.: 18/757,091

(22) Filed: Jun. 27, 2024

(30) Foreign Application Priority Data
Jun. 28, 2023 (JP) 2023-105821

(51) Int. Cl. B41J 29/377

(52) U.S. Cl. CPC B41J 29/377

(57) ABSTRACT

A printing device includes a head, a housing and a chamber. The head is configured to eject ink. In the housing, the head is disposed. The chamber is provided outside the housing and configured to accommodate dehumidified air generated by a dehumidifier. The housing has at least one opening communicating with the chamber.

### REFERENCE TO RELATED APPLICATIONS

This application claims priority from Japanese Patent Application No. 2023-105821 filed on Jun. 28, 2023. The entire content of the priority application is incorporated herein by reference.

### BACKGROUND ART

The present disclosure relates to a printing device capable of supplying dehumidified air into a housing.

JP2011-224932A discloses a printer (printing device) including a drying unit configured to heat a printed sheet (printing medium) to dry ink. In the printer, the drying unit introduces air outside the housing into the housing and circulates hot air heated by a heater inside the housing, thereby reducing humidity inside the housing.

### DESCRIPTION

However, when a use environment of the printer is a high humidity environment, the humidity inside the housing may not be reduced even when the air outside the housing is introduced.

An object of the present disclosure is to provide a printing device capable of reducing the humidity inside the housing regardless of the use environment.

The present disclosure provides a printing device including: a head configured to eject ink; a housing in which the head is disposed; and a chamber provided outside the housing and configured to accommodate dehumidified air generated by a dehumidifier, in which the housing has at least one opening communicating with the chamber.

According to the printing device of the present disclosure, dehumidified air in a chamber is supplied into the housing through the at least one opening. Therefore, regardless of the use environment, the humidity inside the housing can be reduced.

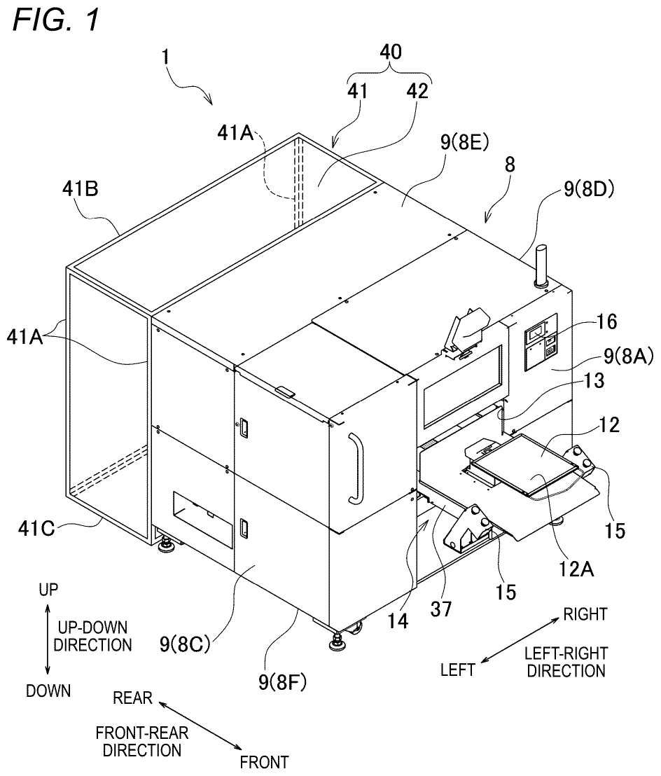

FIG. 1 is a schematic perspective view of a printing device according to a first embodiment of the present disclosure.

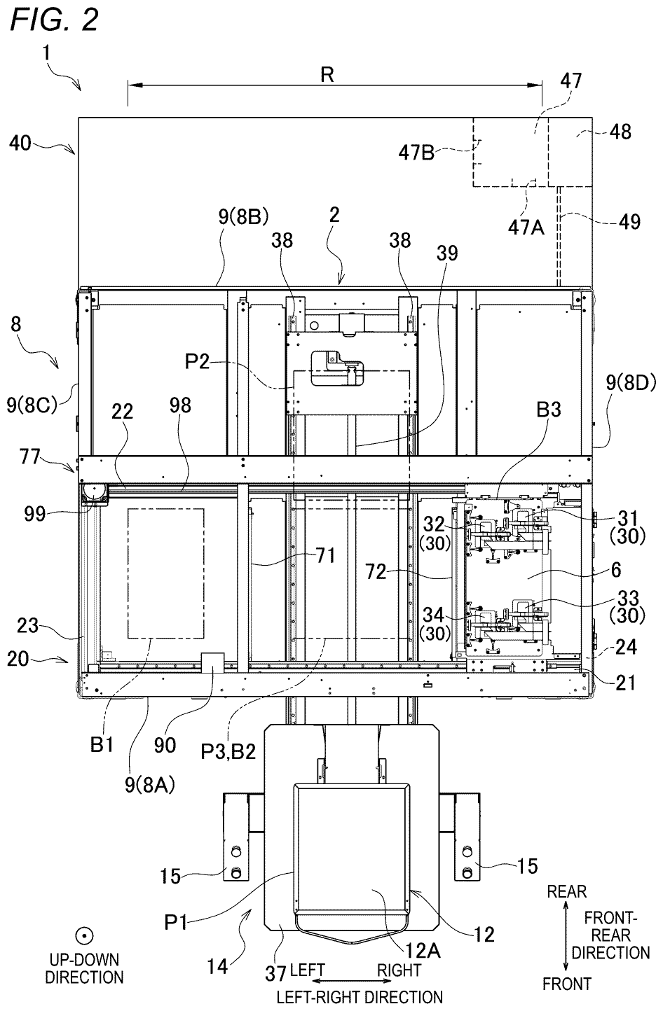

FIG. 2 is a plan view illustrating an internal structure of the printing device illustrated in FIG. 1.

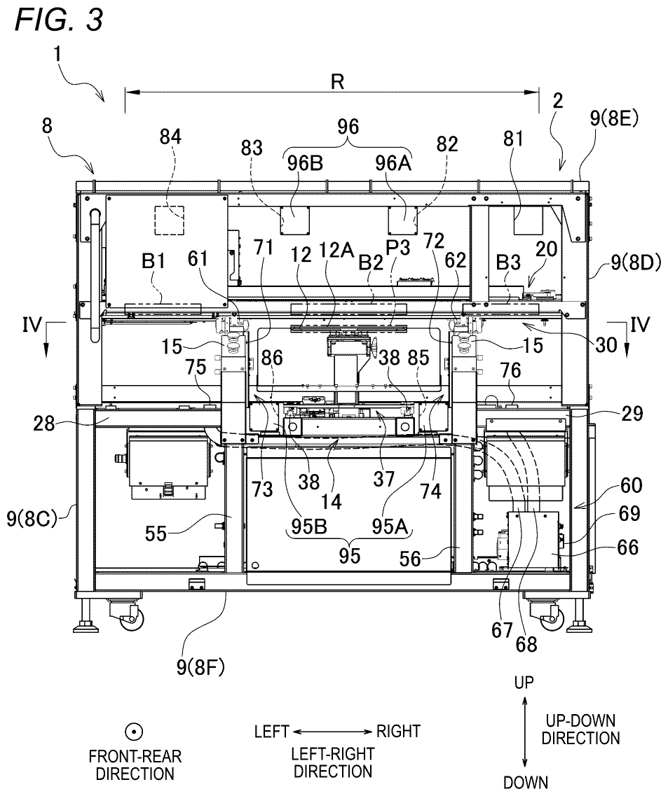

FIG. 3 is a front view illustrating the internal structure of the printing device illustrated in FIG. 1.

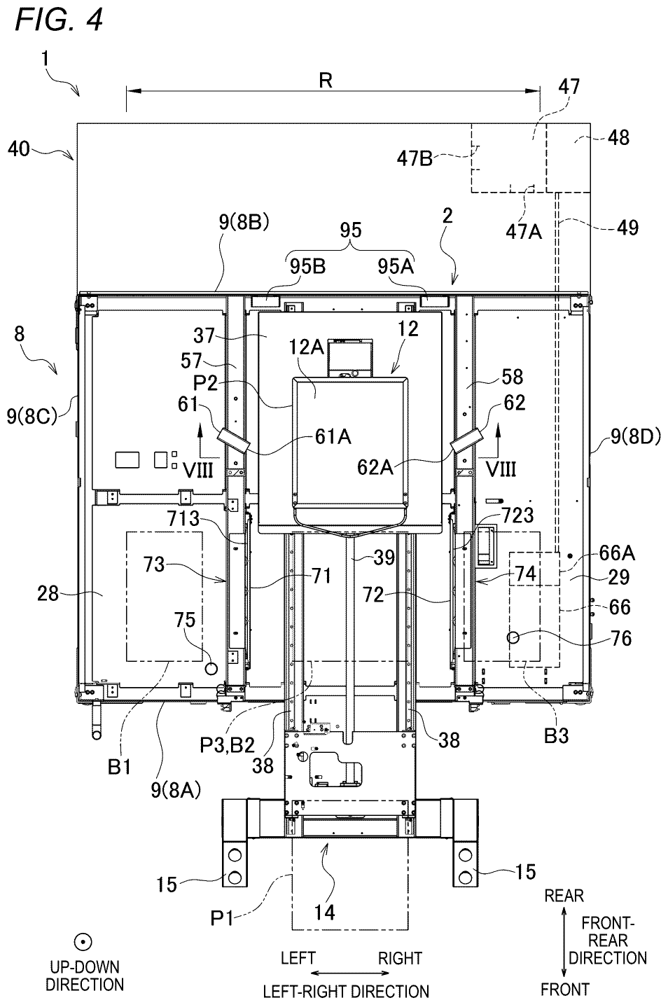

FIG. 4 is a cross-sectional view taken along a line IV-IV illustrated in FIG. 3.

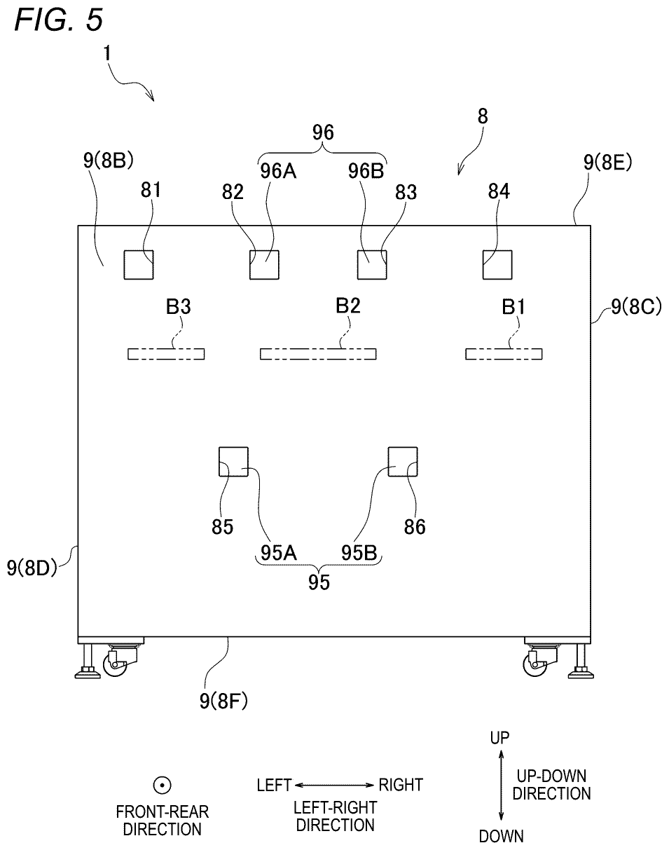

FIG. 5 is a rear view of a housing illustrated in FIG. 1 when viewed from a rear side.

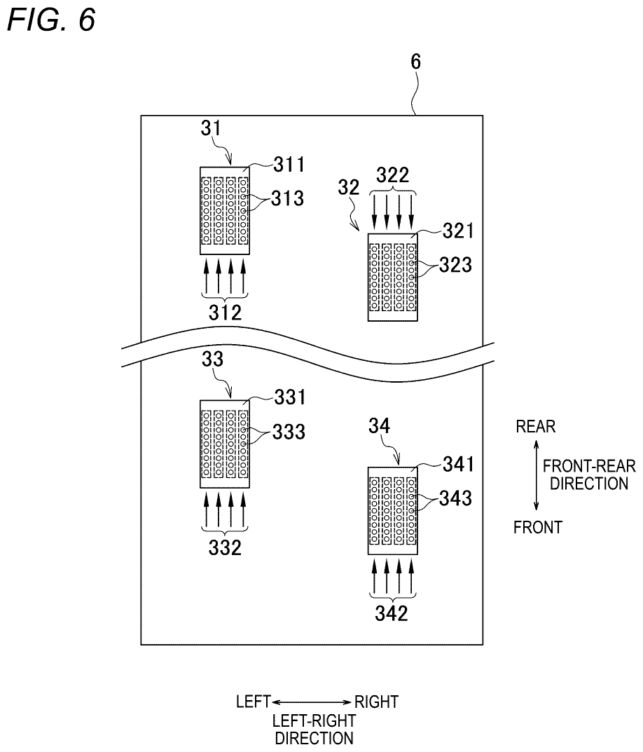

FIG. 6 is a schematic view of a carriage when viewed from below.

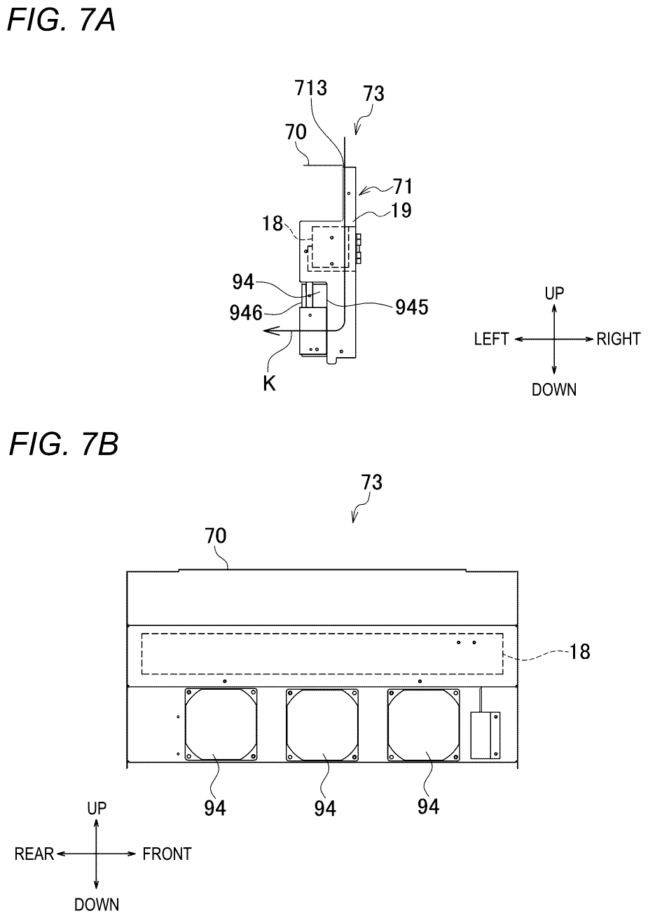

FIG. 7A is a front view of a suction mechanism, and FIG. 7B is a side view of the suction mechanism.

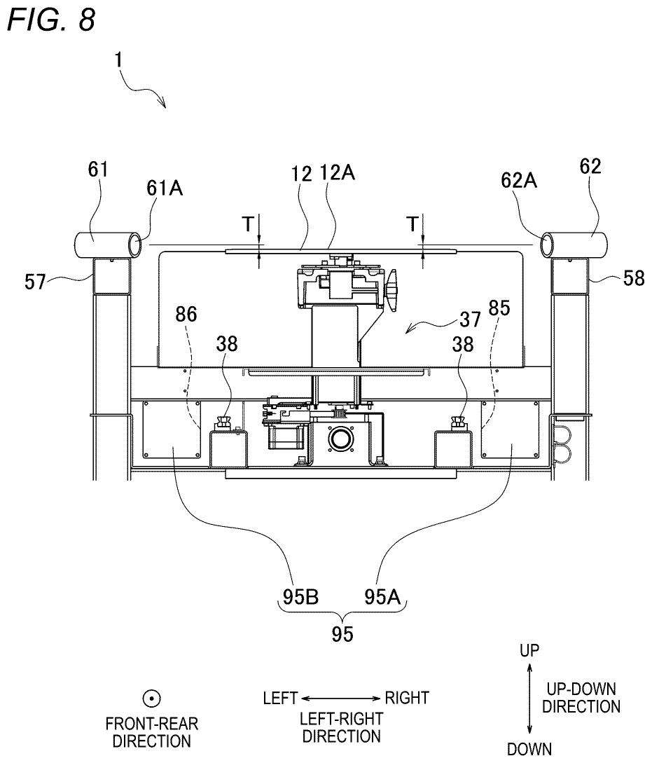

FIG. 8 is a sectional view taken along a line VIII-VIII illustrated in FIG. 4.

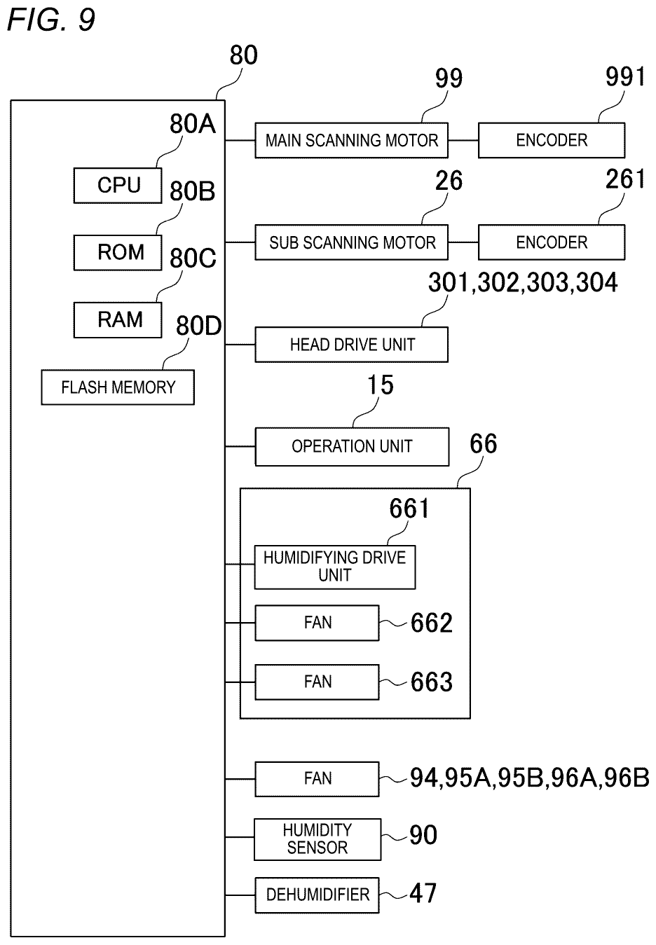

FIG. 9 is a block view illustrating an electrical configuration of the printing device illustrated in FIG. 1.

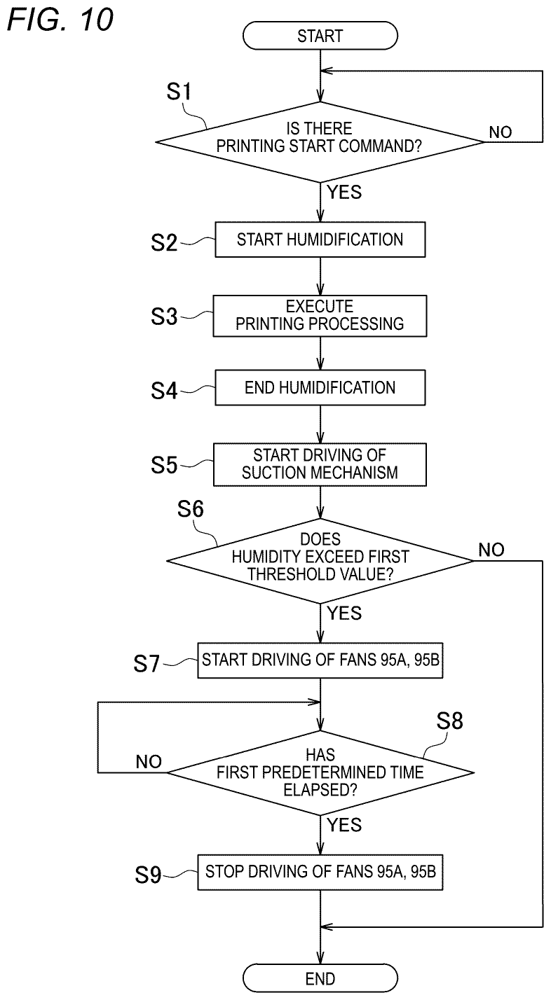

FIG. 10 is a flowchart illustrating an example of a processing procedure executed when a printing start command is input to the printing device illustrated in FIG. 1.

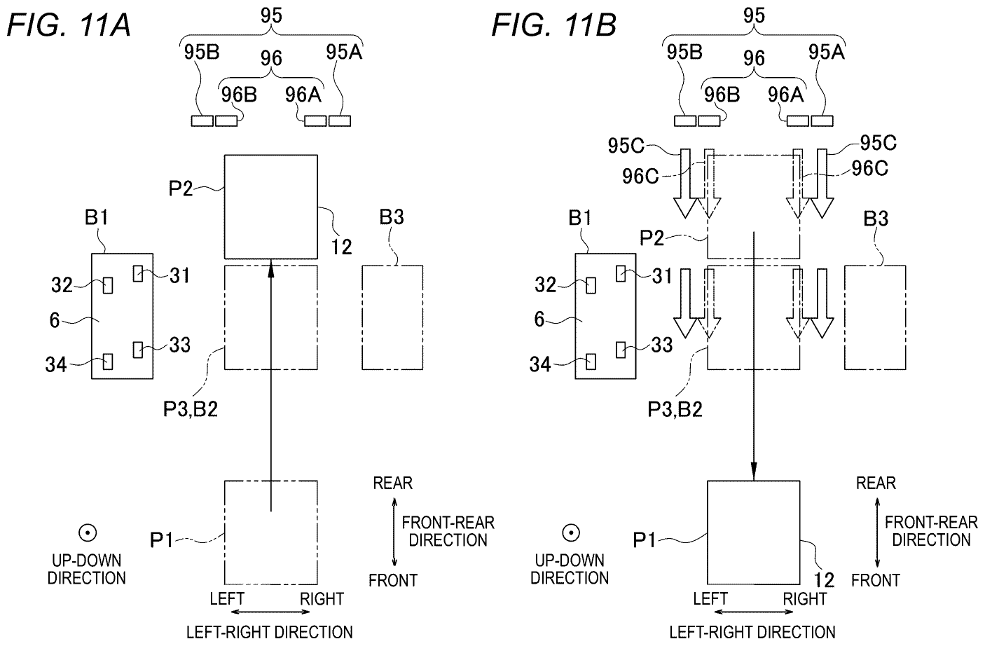

FIG. 11A is a view illustrating a situation in which a platen is conveyed from a set position to a pre-printing standby position, and FIG. 11B is a view illustrating a situation in which the platen is conveyed from the pre-printing standby position to the set position.

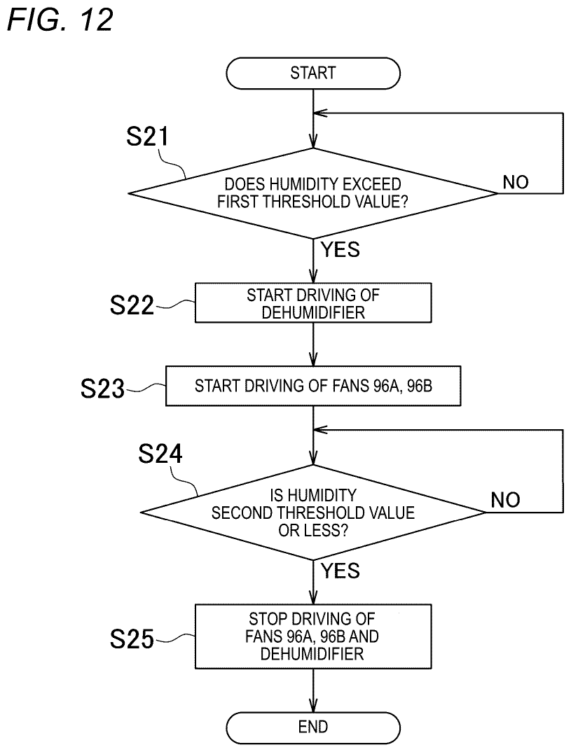

FIG. 12 is a flowchart illustrating an example of a processing procedure of dehumidifying control of the printing device illustrated in FIG. 1.

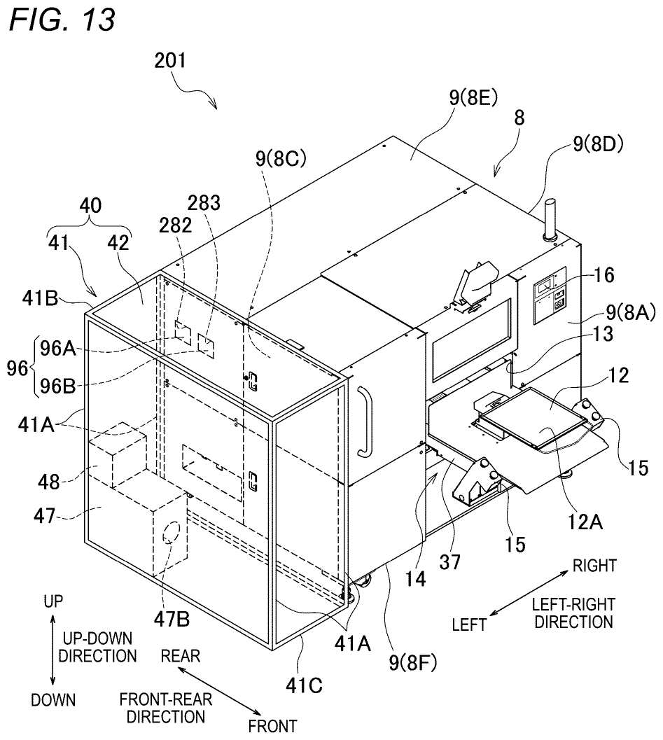

FIG. 13 is a schematic perspective view of a printing device according to a second embodiment of the disclosure.

### FIRST EMBODIMENT

A printing device 1 according to the first embodiment of the present disclosure will be described with reference to the drawings. In the following description, an up-down direction and a front-rear direction (an example of a “first direction”) are defined based on a state in which the printing device 1 is installed so as to be usable (state of FIG. 1), and a left-right direction (a direction intersecting the front-rear direction; an example of a “second direction”) is defined when the printing device 1 is viewed from the front. In the following description, the left-right direction may be referred to as a main scanning direction, and the front-rear direction may be referred to as a sub scanning direction.

The printing device 1 illustrated in FIG. 1 is an ink jet printer, and executes printing by ejecting ink onto a printing medium. The printing device 1 can print a color image on a printing medium using ink of five colors of white, black, yellow, cyan, and magenta. The printing medium is not particularly limited as long as an image can be formed thereon by ejecting ink, and examples thereof include fabric and paper. In the present embodiment, the printing medium is, for example, a T-shirt containing polyester fibers. When the printing device 1 executes printing on the printing medium (T-shirt), the printing medium to which a pretreatment liquid has been applied in advance is placed on a platen 12. The pretreatment liquid reacts with ink ejected onto the pretreatment liquid to aggregate components of the ink, thereby preventing occurrence of bleeding. A volatile component of the pretreatment liquid contains an organic acid such as formic acid.

Hereinafter, the ink of white among the ink of five colors is referred to as the “white ink”. Among the ink of five colors, in a case where the ink of four colors of black, cyan, yellow, and magenta are collectively referred to, or in a case where none of the ink of the four colors is specified, the ink is referred to as the “color ink”. The white ink and the color ink are simply referred to as “ink” when collectively referred to, or when not specifying one among them. The white ink is used for printing as a portion representing white of an image or as a base of the color ink. The color ink is ejected onto the base obtained by the white ink and is used for printing a color image.

An external configuration of the printing device 1 will be described with reference to FIGS. 1 to 3. As illustrated in FIG. 1, the printing device 1 includes a housing 8, a platen 12, a conveyance mechanism 14, an operation unit 15, a display screen 16, a chamber 40, a dehumidifier 47 (see FIG. 2), and a dehumidifying tank 48 (see FIG. 2). The housing 8 has a substantially rectangular parallelepiped shape. A rectangular platen opening (an example of a “passing port”) 13 is formed in substantially a center of a front surface 8A (an example of “one surface”) of the housing 8 in the left-right and up-down directions. Five cartridges (not illustrated) in which the ink of five colors is stored are accommodated in the housing 8. As illustrated in FIG. 2, the platen (an example of a “support portion”) 12 is a plate-like member having a substantially rectangular planar shape. An upper surface of the platen 12 is a support surface 12A that supports the printing medium. The support surface 12A has a square shape.

The operation unit 15 is provided at a position that sandwich, in the left-right direction, a platen support portion 37 (to be described later) located forward of the platen opening 13. The operation unit 15 outputs information corresponding to an operation by a user to a controller 80 to be described later. By operating the operation unit 15, the user can input, to the controller 80, a printing start command (including print data) for starting printing by the printing device 1, a supply start command of dehumidified air, a supply stop command of the dehumidified air, and the like. The display screen 16 is provided on an upper right side of the front surface 8A of the housing 8 with respect to the platen opening 13. The display screen 16 displays various kinds of information.

The conveyance mechanism 14 conveys the platen 12, on which the printing medium is placed, between an inside of the housing 8 and an outside of the housing 8 through the platen opening 13. When the platen 12 is disposed in a printing conveyance region P3 (position indicated by a two-dot chain line in FIG. 2) inside the housing 8 illustrated in FIG. 2, the ink is ejected from a head 30 to be described later, and the printing is executed. As illustrated in FIG. 2, the conveyance mechanism 14 includes the platen support portion 37, a pair of right and left rails 38, a transmission member 39, and a sub scanning motor 26 (see FIG. 8).

As illustrated in FIGS. 2 and 3, the platen support portion 37 supports the platen 12 from below. The pair of left and right rails 38 extends in the front-rear direction and supports the platen support portion 37 so as to be movable in the front-rear direction. The transmission member 39 is coupled to the platen support portion 37 and the sub scanning motor 26, and moves the platen support portion 37 in the front-rear direction, that is, the sub scanning direction, in accordance with driving of the sub scanning motor 26.

An operator places the printing medium on the support surface 12A of the platen 12 in a state where the platen 12 is disposed on a front side of the front surface 8A of the housing 8, that is, outside the housing 8. A position of the platen 12 illustrated in FIG. 2 is a set position P1 at which the printing medium is supported by the platen 12. In addition, before printing on the printing medium, the platen 12 moves from the set position P1 to a pre-printing standby position P2 (position indicated by a two-dot chain line in FIG. 2). The pre-printing standby position P2 is located backward of the printing conveyance region P3 and at a rear end portion of a conveyance path of the platen 12. In the conveyance path of the platen 12, the printing conveyance region P3 is a region that overlaps, in the up-down direction, with a movement path of the head 30 in the main scanning direction (left-right direction) to be described later. A width of the movement path of the head 30 in the main scanning direction in the front-rear direction is between a rear end of a rearmost head 30 (white head 31) and a front end of a frontmost head 30 (color head 34).

A structure inside the housing 8 of the printing device 1 will be described with reference to FIGS. 2 to 8. As illustrated in FIGS. 1 and 2, the housing 8 includes a frame body 2, and an outer peripheral panel 9 which covers an outer periphery of the frame body 2 and constitutes the front surface 8A, a rear surface 8B, a left side surface 8C, a right side surface 8D, an upper surface 8E, and a lower surface 8F.

As illustrated in FIGS. 2 to 4, the frame body 2 is formed in a lattice shape with a plurality of shafts extending in the front-rear direction including shafts 57 and 58, a plurality of shafts extending in the left-right direction, and a plurality of shafts extending in the up-down direction including shafts 55 and 56.

The platen opening 13 described above is formed in the front surface 8A. As illustrated in FIG. 5, four first openings 81 to 84 and two second openings 85 and 86 are formed in the rear surface 8B (an example of “another surface”). The first openings 81 to 84 and the second openings 85 and 86 penetrate the outer peripheral panel 9 in a thickness direction thereof, and allow the inside of the housing 8 and the outside of the housing 8 to communicate with each other.

As illustrated in FIG. 5, the four first openings 81 to 84 are disposed higher than (on an upper side than) a maintenance position B1, an ejection region B2, and a head standby position B3 which are to be described later, on which the head 30 is mainly disposed. That is, the first openings 81 to 84 are located higher than nozzle surfaces 311, 321, 331, and 341 (to be described later) of the head 30. In addition, the first openings 81 to 84 are disposed to be separated from one another along the left-right direction. The first opening 81 is disposed on a right side with respect to a center portion of the rear surface 8B in the left-right direction. The first opening 84 is disposed on a left side with respect to the center portion of the rear surface 8B in the left-right direction. The first openings 82 and 83 are disposed in the center portion of the rear surface 8B in the left-right direction.

As illustrated in FIG. 5, the two second openings 85 and 86 are located lower than (on a lower side than) the nozzle surfaces 311, 321, 331, and 341 (to be described later) of the head 30. In addition, the second opening 85 is disposed between the first openings 81 and 82 in the left-right direction. The second opening 86 is disposed between the first openings 83 and 84 in the left-right direction.

As long as the four first openings 81 to 84 are disposed higher than the nozzle surfaces 311, 321, 331, and 341, at least any of the first openings 81 to 84 may be disposed to be shifted in the up-down direction. In addition, as long as the two second openings 85 and 86 are disposed lower than the nozzle surfaces 311, 321, 331, and 341, the two second openings 85 and 86 may be disposed to be shifted from each other in the up-down direction.

As illustrated in FIG. 2, a pair of inner walls 71 and 72, partition plates 28 and 29 (see FIG. 3), heads 31 to 34, a moving mechanism 77, suction mechanisms 73 and 74 (see FIG. 3), a humidifying mechanism 60 (see FIG. 3), a humidity sensor 90, and air blowing mechanisms 95 and 96 (see FIG. 3) are provided in the housing 8. The moving mechanism 77 includes a guide shaft 20 fixed to the frame body 2 and a carriage 6. The guide shaft 20 includes a front shaft 21, a rear shaft 22, a left shaft 23, and a right shaft 24. The conveyance mechanism 14 is fixed to the frame body 2.

As illustrated in FIGS. 2 to 4, the pair of inner walls 71 and 72 are disposed to be separated from each other while facing each other in the left-right direction. For example, as illustrated in FIG. 2, the pair of inner walls 71 and 72 are disposed so as to sandwich the conveyance path of the platen 12 in the left-right direction in a plan view. As illustrated in FIG. 3, the inner walls 71 and 72 extend in the up-down direction and the front-rear direction on a lower side than the guide shaft 20 and are fixed to the frame body 2. As illustrated in FIG. 4, the inner wall 71 is provided to the left of the printing conveyance region P3 and is fixed to the shaft 57. The inner wall 72 is provided to the right of the printing conveyance region P3 and is fixed to the shaft 58.

As illustrated in FIGS. 3 and 4, the partition plate 28 is fixed to the frame body 2 on the lower side than the guide shaft 20 and to the left of the inner wall 71. The partition plate 28 extends along the front-rear direction and the left-right direction. A right end portion of the partition plate 28 is connected to a lower end portion of the inner wall 71.

As illustrated in FIGS. 3 and 4, the partition plate 29 is fixed to the frame body 2 on the lower side than the guide shaft 20 and to the right of the inner wall 72. The partition plate 29 extends along the front-rear direction and the left-right direction. A left end portion of the partition plate 29 is connected to a lower end portion of the inner wall 72.

As illustrated in FIG. 4, a supply port 75 having a circular shape in a plan view and penetrating the partition plate 28 in the up-down direction, is formed in a right front portion of the partition plate 28. A supply port 76 having a circular shape in a plan view and penetrating the partition plate 29 in the up-down direction, is formed in a left front portion of the partition plate 29. A positional relation between the supply port 75 and the supply port 76 is not particularly limited, but in the present embodiment, the supply port 75 is formed forward of the supply port 76 in the front-rear direction. Pipes (not illustrated) are connected to the supply ports 75 and 76, and are connected to humidified air supply pipes 61 and 62 to be described later.

As illustrated in FIG. 2, the carriage 6 is supported by the front shaft 21 and the rear shaft 22 so as to be movable in the main scanning direction. The carriage 6 has a plate shape and extends in the front-rear and left-right directions. The carriage 6 extends from the front shaft 21 to the rear shaft 22.

As illustrated in FIGS. 2 and 6, the carriage 6 is provided with white heads 31 and 32 and color heads 33 and 34. The white heads 31 and 32 and the color heads 33 and 34 constitute the “head”.

The white heads 31 and 32 and the color heads 33 and 34 have the same structure, respectively, and have a rectangular parallelepiped shape in the present embodiment. Hereinafter, in a case where the white heads 31 and 32 and the color heads 33 and 34 are collectively referred to, or in a case where none of the heads is not specified, the heads are simply referred to as the “head 30”. As illustrated in FIG. 6, the white heads 31 and 32 are located at a rear portion of the carriage 6. The white head 31 is located at a right rear portion of the carriage 6. The white head 32 is located on a left side with respect to the white head 31, and is disposed to be shifted to a front side with respect to the white head 31.

As illustrated in FIGS. 2 and 6, the color heads 33 and 34 are located to a front side with respect to the white heads 31 and 32 in the sub scanning direction. The color heads 33 and 34 are located at the same positions as the white heads 31 and 32 in the left-right direction, respectively. That is, the color head 34 is located on a left side with respect to the color head 33, and is disposed to be shifted to the front side with respect to the color head 33.

As illustrated in FIG. 6, the nozzle surface 311 is provided on a lower surface of the white head 31. The nozzle surface 311 extends in the front-rear and left-right directions. A plurality of nozzle arrays 312 are formed on the nozzle surface 311. The plurality of nozzle arrays 312 are arranged in the left-right direction. Each of the nozzle arrays 312 includes a plurality of nozzles 313 arranged in a row at equal intervals in the front-rear direction. The plurality of nozzles 313 are openings and eject the white ink downward.

Similarly to a configuration of the white head 31, the nozzle surfaces 321, 331, and 341 are provided on lower surfaces of the white head 32 and the color heads 33 and 34, respectively. The nozzle surfaces 321, 331, and 341 extend in the front-rear and left-right directions. A plurality of nozzle arrays 322, 332, and 342 are formed on the nozzle surfaces 321, 331, and 341, respectively. The plurality of nozzle arrays 322, 332, and 342 are arranged in the left-right direction, respectively. The plurality of nozzle arrays 322, 332, and 342 include a plurality of nozzles 323, 333, and 343 arranged in a row at equal intervals in the front-rear direction, respectively.

The plurality of nozzles 323 eject the white ink downward. Color ink of different colors corresponds to the plurality of nozzle arrays 332, respectively. That is, the plurality of nozzles 333 eject color ink of a color corresponding to each of the plurality of nozzle arrays 332 downward. Color ink of different colors corresponds to the plurality of nozzle arrays 342, respectively. The plurality of nozzles 343 eject color ink of a color corresponding to each of the plurality of nozzle arrays 342 downward.

The moving mechanism 77 includes a drive belt 98 and a main scanning motor 99. The drive belt 98 is connected to a rear end portion of the carriage 6. The drive belt 98 is provided on the rear shaft 22 and extends in the left-right direction. A left end portion of the drive belt 98 is connected to the main scanning motor 99. When the main scanning motor 99 is driven, the drive belt 98 moves the carriage 6 in the left-right direction along the front shaft 21 and the rear shaft 22. That is, the moving mechanism 77 moves the carriage 6 on which the head 30 is mounted in the main scanning direction. FIGS. 2 and 3 illustrate a state where the carriage 6 is located at a right end of a moving range R.

In FIGS. 2 and 3, the moving range R of the head 30 is shown as a maximum range in which the carriage 6 can move in the main scanning direction. As illustrated in FIG. 3, the head 30 is mainly disposed at any of the maintenance position B1, the ejection region B2, and the head standby position B3 by the moving mechanism 77. The maintenance position B1 is a left end portion of the moving range R of the head 30, and is a position where the head 30 is maintained by a maintenance unit such as a wiper or a cap (not illustrated). The printing device 1 moves the head 30 to the maintenance position B1 during non-printing, and executes the maintenance by the maintenance unit. The ejection region B2 is a region between the maintenance position B1 and the head standby position B3 in the main scanning direction, and overlaps with the conveyance path (printing conveyance region P3) of the platen 12 in the up-down direction in the movement path of the head 30. In addition, when the head 30 passes through the ejection region B2 by the carriage 6, the head 30 ejects ink according to the print data, and printing is executed on the printing medium on the platen 12. The head standby position B3 is at a right end of the moving range R of the head 30, and is a position where the head is disposed in a case where the operator performs an operation such as cleaning the head 30. For example, the printing device 1 moves the head 30 to the head standby position B3 and causes the head 30 to stand by based on an instruction input from the operation unit 15 by a user operation.

In the printing device 1, by moving the platen 12 in the sub scanning direction by driving of the sub scanning motor 26 in the printing conveyance region P3, and moving the carriage 6 in the main scanning direction by driving of the main scanning motor 99 in the ejection region B2, the printing medium moves relative to the head 30 in the sub scanning direction and the main scanning direction.

An operation of moving the head 30 in the main scanning direction and ejecting ink onto the printing medium when the head 30 faces the printing medium is referred to as “ejection scanning”. The printing device 1 executes printing on the printing medium by repeating the ejection scanning and the moving of the platen 12 in the sub scanning direction. For example, the printing device 1 ejects white ink from the white heads 31 and 32 to form a base on the printing medium in the ejection scanning. The printing device 1 prints a color image by ejecting color ink from the color heads 33 and 34 onto the base formed on the printing medium in the ejection scanning.

As illustrated in FIG. 3, the suction mechanisms 73 and 74 mainly suck air in the printing conveyance region P3, the ejection region B2, and a space in the vicinity of the regions. In the main scanning direction, the suction mechanism 73 is provided on a left side of the conveyance mechanism 14 inside the housing 8 (see FIG. 1), and the suction mechanism 74 is provided on a right side of the conveyance mechanism 14 inside the housing 8. The suction mechanisms 73 and 74 are bilaterally symmetrical to each other.

As illustrated in FIGS. 7A and 7B, the suction mechanism 73 includes the inner wall 71, three fans 94, and a filter unit 18. A slit-shaped suction port 713 that is elongated in the front-rear direction is formed in an upper surface of the inner wall 71.

As illustrated in FIG. 7A, the inner wall 71 includes a fixing plate 70 and an accommodation portion 19. The fixing plate 70 is a plate-like portion extending in the left-right direction at an upper end of the inner wall 71. As illustrated in FIG. 4, the fixing plate 70 is fixed to the shaft 57 extending in the front-rear direction. The accommodation portion 19 has a box shape and detachably accommodates the filter unit 18. The filter unit 18 is accommodated inside the inner wall 71 by being accommodated in the accommodation portion 19. The filter unit 18 has a rectangular parallelepiped shape that is elongated in the front-rear direction. In addition, the filter unit 18 includes a filter and a support body that supports the filter. The filter is, for example, a resin filter having a plurality of minute holes formed thereon, and adsorbs and collects foreign matter such as mist and dust in the air.

As illustrated in FIG. 7A, the three fans 94 are provided in a lower portion of a left surface of the inner wall 71. As illustrated in FIG. 7B, the three fans 94 are arranged at substantially equal intervals in the front-rear direction. As illustrated in FIG. 4, when each of the fans 94 of the suction mechanism 73 is driven, air is sucked into the inner wall 71 from the suction port 713 of the inner wall 71. The air sucked into the inner wall 71 passes through the filter of the filter unit 18, and foreign matter in the air is collected. The air from which the foreign matter is collected is discharged from a space inside the inner wall 71 through an intake port 945 and an exhaust port 946 of the fan 94. That is, in a case where the fan 94 is driven, as illustrated in FIG. 7A, air flows in the space inside the inner wall 71 as indicated by an arrow K.

As illustrated in FIG. 4, the suction mechanism 74 includes the inner wall 72, three fans (not illustrated), and a filter unit (not illustrated) corresponding to the inner wall 71, the three fans 94, and the filter unit 18 of the suction mechanism 73, respectively. A slit-shaped suction port 723 that is elongated in the front-rear direction and corresponds to the suction port 713 is formed on an upper surface of the suction mechanism 74. In a case where each fan of the suction mechanism 74 is driven, air flows from the suction port 723 to a space inside the inner wall 72. Thereafter, the air passes through the filter of the filter unit when flowing from an upper side to a lower side of the space. Then, the air flows from a lower portion of the space to a right side where the fan is located, and is discharged from the space.

The suction mechanisms 73 and 74 may include the inner walls 71 and 72 and the fan 94, respectively, and may not include the filter unit 18.

As illustrated in FIG. 3, the humidifying mechanism 60 includes the two humidified air supply pipes 61 and 62 and a humidifier 66. The humidifier 66 supplies humidified air to the supply port 75 disposed on a left side of the suction mechanism 73 and the supply port 76 disposed on a right side of the suction mechanism 74. The humidifier 66 is provided inside the housing 8 and on the lower side than the partition plate 29. In addition, the humidifier 66 includes a humidifying tank 66A (see FIG. 4), a humidifying drive unit 661 (see FIG. 9), an intake port 69 for taking air into the humidifier 66, two tubes 67 and 68, and fans 662 and 663 (see FIG. 9). The humidifying tank 66A stores water used for humidification. A liquid other than water may be used for the humidification. As illustrated in FIG. 4, one end of a pipe (an example of a “communication flow path”) 49 is connected to the humidifying tank 66A. The other end of the pipe 49 is connected to the dehumidifying tank 48. That is, the humidifying tank 66A and the dehumidifying tank 48 communicate with each other through the pipe 49. A water supply pipe may be connected to the humidifying tank 66A, and water may be supplied to the humidifying tank 66A from an external device such as waterworks and a water supply tank (not illustrated).

The humidifying drive unit 661 humidifies the air taken into the humidifier 66 through the intake port 69 using the water stored in the humidifying tank 66A. The humidifying drive unit 661 may humidify the air by any method such as a steam method, a vaporization method, an ultrasonic method, and an electrolysis method. One end of the tube 67 is connected to the humidifier 66, and the other end thereof is connected to the supply port 75. One end of the tube 68 is connected to the humidifier 66, and the other end thereof is connected to the supply port 76.

The fan 662 supplies air humidified by the humidifying drive unit 661 to the supply port 75 via the tube 67 illustrated in FIG. 3. The fan 663 supplies the air humidified by the humidifying drive unit 661 to the supply port 76 via the tube 68 illustrated in FIG. 3. The humidified air supplied to the supply port 75 is sent to a support surface 12A side of the platen 12 through the humidified air supply pipe 61 to be described later. In addition, the humidified air supplied to the supply port 76 is also sent to the support surface 12A side of the platen 12 through the humidified air supply pipe 62 to be described later. That is, the humidified air supplied from the humidifier 66 is sent toward the printing medium supported by the platen 12.

As illustrated in FIGS. 4 and 8, the two humidified air supply pipes 61 and 62 are fixed to the frame body 2 (shafts 57 and 58). The humidified air supply pipes 61 and 62 are formed of straight pipes. The two humidified air supply pipes 61 and 62 are disposed around and behind the platen 12 disposed in the printing conveyance region P3.

The humidified air supply pipe 61 has a humidified air supply port 61A at one end thereof, and a pipe (not illustrated) connected to the supply port 75 is connected to the other end thereof. The humidified air supply pipe 62 has a humidified air supply port 62A at one end thereof, and a pipe (not illustrated) connected to the supply port 76 is connected to the other end thereof. More specifically, the pipe connected to the supply port 75 is connected to the humidified air supply pipe 61. The pipe connected to the supply port 76 is connected to the humidified air supply pipe 62.

The two humidified air supply pipes 61 and 62 are disposed inclined with respect to the front-rear direction and the left-right direction such that the humidified air supply ports 61A and 62A face the support surface 12A side of the platen 12 disposed in the printing conveyance region P3. The two humidified air supply ports 61A and 62A face forward.

As illustrated in FIG. 8, the two humidified air supply ports 61A and 62A are disposed at the same position in the up-down direction. More specifically, the two humidified air supply ports 61A and 62A are disposed higher than the platen 12 such that a distance from a central axis (central axis passing through a center of an opening) to the support surface 12A of the platen 12 is a predetermined distance T in the up-down direction. The two humidified air supply ports 61A and 62A open toward a space region (region between the head 30 and the support surface 12A in the up-down direction) on the support surface 12A of the platen 12 disposed in the printing conveyance region P3.

The humidified air supplied from the two humidified air supply ports 61A and 62A is supplied from the vicinity of two rear corners of the platen 12 disposed in the printing conveyance region P3 toward the front of the platen 12. Accordingly, a large amount of humidified air is supplied to the space region between the platen 12 and upper and lower sides of the head 30.

As illustrated in FIG. 2, the humidity sensor 90 is disposed inside the housing 8. More specifically, the humidity sensor 90 is disposed on a left side with respect to the platen opening 13, and is fixed to a back side of the front surface 8A of the housing 8. In addition, the humidity sensor 90 is disposed higher than the head 30. Further, the humidity sensor 90 detects humidity inside the housing 8 and outputs a signal indicating the humidity to the controller 80.

As illustrated in FIG. 3, the air blowing mechanism 95 (an example of a “second air blower”) includes two fans 95A and 95B. The two fans 95A and 95B are disposed on an outer side with respect to the pair of rails 38 and on an inner side of the pair of inner walls 71 and 72 in the left-right direction. In addition, the two fans 95A and 95B are disposed such that centers thereof are located slightly lower than the pair of rails 38 in the up-down direction. The air blowing mechanism 95 is located on a side opposite to the platen opening 13 with respect to the head 30 in the front-rear direction.

The two fans 95A and 95B are fixed to the outer peripheral panel 9 constituting the rear surface 8B of the housing 8. More specifically, the fan 95A is provided in the second opening 85, and the fan 95B is provided in the second opening 86. The fan 95A covers the second opening 85, and the fan 95B covers the second opening 86. In a case where the two fans 95A and 95B are driven, air flows from the rear toward the front. That is, the air blowing mechanism 95 supplies air of the outside (inside chamber 40) of the housing 8 into the housing 8 through the second openings 85 and 86, blows the air inside the housing 8 from the rear toward the front, and discharges the air to the outside through the platen opening 13.

The two fans 95A and 95B are disposed at positions facing the platen opening 13 in the front-rear direction. Therefore, the air sent by the air blowing mechanism 95 is effectively discharged from the inside of the housing 8 to the outside through the platen opening 13.

As illustrated in FIG. 3, the air blowing mechanism 96 (an example of a “first air blower” and an “air blower”) also includes two fans 96A and 96B. In addition, the air blowing mechanism 96 is located on a side opposite to the head 30 from the platen opening 13 in the front-rear direction. The two fans 96A and 96B are fixed to the outer peripheral panel 9 constituting the rear surface 8B of the housing 8. More specifically, the fan 96A is provided in the first opening 82, and the fan 96B is provided in the first opening 83. The fan 96A covers the first opening 82, and the fan 96B covers the first opening 83. In a case where the two fans 96A and 96B are driven, air flows from the rear toward the front as in the case of the above-described two fans 95A and 95B. That is, the air blowing mechanism 96 also supplies air of the outside (inside chamber 40) of the housing 8 into the housing 8 through the first openings 82 and 83, blows the air inside the housing 8 from the rear toward the front, and discharges the air to the outside through the platen opening 13.

When at least any of the air blowing mechanisms 95 and 96 is driven, the air inside the housing 8 is discharged from the platen opening 13, generating an airflow. When the airflow is generated in the housing 8, the air inside the chamber 40 is supplied into the housing 8 through the first openings 81 and 84. In addition, since the openings 81 to 86 are formed in the housing 8, the air inside the chamber 40 automatically flows into the housing 8.

The chamber 40 is disposed behind the housing 8 and adjacent to the rear surface 8B. The chamber 40 includes a frame body 41 and a sheet 42, and has a substantially rectangular parallelepiped shape. The frame body 41 includes four support columns 41A extending in the up-down direction, an upper frame 41B, and a lower frame 41C. The upper frame 41B includes two horizontal frames extending in the left-right direction and two horizontal frames extending in the front-rear direction, and is formed in a rectangular frame shape. The lower frame 41C also includes two horizontal frames extending in the left-right direction and two horizontal frames extending in the front-rear direction, and is formed in a rectangular frame shape. The frame body 41 is formed by connecting the upper frame 41B and the lower frame 41C by the four support columns 41A.

The sheet 42 is disposed so as to cover an upper side, left and right lateral sides, and an entire rear side of the frame body 41. The sheet 42 in the present embodiment is translucent, but may be transparent or non-transparent. In addition, a plate-like panel may be provided instead of the sheet 42 of the chamber 40. In short, the chamber 40 may have a space for accommodating air therein.

As illustrated in FIGS. 2 and 4, the dehumidifier 47 and the dehumidifying tank 48 are disposed inside the chamber 40. The dehumidifier 47 is a known dehumidifier, and has an air inlet 47A for sucking the air inside the chamber 40 and a supply port 47B. The dehumidifier 47 is driven to generate dehumidified air in which moisture is removed from the air inside the chamber 40 sucked in through the air inlet 47A, and supplies the dehumidified air into the chamber 40 through the supply port 47B. The dehumidifier 47 dehumidifies the air inside the chamber 40. The dehumidifying tank 48 stores water generated when the dehumidifier 47 generates the dehumidified air. In addition, the dehumidifying tank 48 in the present embodiment is disposed higher than the dehumidifier 47, but the dehumidifying tank 48 may be disposed higher than the humidifying tank 66A. Accordingly, the water stored in the dehumidifying tank 48 is automatically supplied to the humidifying tank 66A through the pipe 49. Therefore, it is possible to use water generated by the dehumidification for humidification. Further, an effort to discard the water stored in the dehumidifying tank 48 can also be saved. In addition, the dehumidifying tank 48 may be built in the dehumidifier 47.

An electrical configuration of the printing device 1 will be described with reference to FIG. 9. The printing device 1 includes the controller 80. The controller 80 includes a CPU 80A, a ROM 80B, a RAM 80C, and a flash memory 80D. The CPU 80A controls the printing device 1 and is electrically connected to the ROM 80B, the RAM 80C, and the flash memory 80D. The ROM 80B stores a control program for the CPU 80A to control an operation of the printing device 1, information necessary for the CPU 80A to execute various programs, and the like. The ROM 80B stores, for example, each position of the carriage 6 (head 30) based on a rotation angle of the main scanning motor 99, and stores each position of the platen 12 based on a rotation angle of the sub scanning motor 26. The RAM 80C temporarily stores various types of data used in the control program, and the like. The flash memory 80D is nonvolatile and stores print data and the like for printing.

As illustrated in FIG. 9, the main scanning motor 99, the sub scanning motor 26, four head drive units 301 to 304, the humidifier 66, the dehumidifier 47, the humidity sensor 90, the fans 94, 95A, 95B, 96A, and 96B, and the operation unit 15 are electrically connected to the controller 80. The main scanning motor 99, the sub scanning motor 26, the head drive units 301 to 304, the humidifier 66, the dehumidifier 47, and the fans 94, 95A, 95B, 96A, and 96B are driven under control of the controller 80.

The main scanning motor 99 and the sub scanning motor 26 are provided with encoders 991 and 261, respectively. The encoder 991 detects the rotation angle of the main scanning motor 99 and outputs a detection result to the controller 80. The encoder 261 detects the rotation angle of the sub scanning motor 26 and outputs a detection result to the controller 80.

The four head drive units 301 to 304 correspond to the white heads 31 and 32 and the color heads 33 and 34 in this order, and are included in the heads 31 to 34. Each of the head drive units 301 to 304 is implemented by a plurality of drive elements (piezoelectric elements or heat generating elements) capable of selectively applying energy to ink in a plurality of individual flow paths respectively communicating with the plurality of nozzles of the head 30. The head drive units 301 to 304 respectively apply energy to the ink in the white heads 31 and 32 and the color heads 33 and 34 by driving the white heads 31 and 32 and the color heads 33 and 34, and thus the ink is selectively ejected from the corresponding nozzles 313, 323, 333, and 343.

### <Control During Printing>

The control by the controller 80 when printing an image on the printing medium will be described with reference to FIG. 10. When the user operates the operation unit 15 and inputs the printing start command to the printing device 1, the controller 80 reads a control program from the ROM 80B and operates to execute a flow of FIG. 10. Hereinafter, the flow of FIG. 10 will be described.

First, the controller 80 determines whether the printing start command is input (S1). The user applies a pretreatment liquid to the printing medium before operating the operation unit 15 to input a printing instruction. The pretreatment liquid may be applied from an application mechanism such as a spray or a head provided separately from the printing device 1, in response to input of the printing start command. The printing medium (T-shirt) is disposed on the support surface 12A of the platen 12 before a volatile component of the pretreatment liquid applied to the printing medium is completely volatilized. That is, the printing medium on which the pretreatment liquid is applied can be immediately placed on the platen 12 without particular special processing such as drying the printing medium. In the present embodiment, when S1 is processed, the printing medium immediately after the pretreatment liquid is applied thereto is in a state of being supported by the platen 12. Therefore, during the printing processing to be described later, the organic acid volatilizes from the pretreatment liquid applied to the printing medium. The platen 12 is disposed at the set position P1 during non-printing. In the printing device 1, during non-printing, the head 30 is normally disposed at the maintenance position B1, and capping of covering the plurality of nozzles of the head 30 is executed by a cap of a maintenance unit (not illustrated).

In a case where the printing start command is not input (NO in S1), S1 is repeated until the printing start command is input. On the other hand, in a case where the printing start command is input (YES in S1), the controller 80 controls the humidifier 66 such that the supply of humidified air from the two humidified air supply ports 61A and 62A is started (S2). That is, the controller 80 drives the humidifying drive unit 661 to generate humidified air. Then, the fans 662 and 663 are driven to supply the humidified air from the two humidified air supply ports 61A and 62A. By supplying the humidified air from the two humidified air supply ports 61A and 62A, the humidified air is supplied to the printing conveyance region P3.

Next, the controller 80 executes a printing processing of printing an image on the printing medium (S3). As illustrated in FIG. 11A, the controller 80 controls the sub scanning motor 26 based on a detection result from the encoder 261 to move the platen 12 from the set position P1 to the pre-printing standby position P2 through the printing conveyance region P3. Thereafter, the controller 80 controls the sub scanning motor 26 based on a detection result from the encoder 261 to move the platen 12 from the pre-printing standby position P2 to the printing conveyance region P3.

Then, the controller 80 controls the main scanning motor 99 based on a detection result from the encoder 991 to move the carriage 6 from the maintenance position B1 to the ejection region B2 and cause the head 30 to face the printing medium placed on the platen 12.

The controller 80 controls the head drive units 301 to 304, the main scanning motor 99, and the sub scanning motor 26, and executes printing on the printing medium by alternately repeating the ejection scanning and forward moving of the platen 12, in a state where at least a part of the platen 12 is located in the printing conveyance region P3 and in a state where the carriage 6 is located in the ejection region B2. That is, at the time of the printing on the printing medium, since the platen 12 is conveyed forward from the pre-printing standby position P2 to the printing conveyance region P3, first, the ink is ejected from the nozzles of the white heads 31 and 32 onto the printing medium to which the pretreatment liquid is applied, and a base is formed. Then, after the platen 12 passes through the white heads 31 and 32, the ink is ejected from the nozzles of the color heads 33 and 34 onto the base formed on the printing medium, and an image is formed. A portion representing white of the image is a base portion formed with white ink. Therefore, the color ink is not ejected onto the base portion.

Since the humidified air is supplied from the two humidified air supply ports 61A and 62A after S1 (YES) is processed and before the printing processing is executed, the humidified air is supplied onto the printing medium when the platen 12 passes through under the head 30 or when the printing on the printing medium is executed. That is, a humidified air layer exists on the printing medium. Therefore, the volatile component of the pretreatment liquid applied to the printing medium is less likely to volatilize. In addition, even when the volatile component of the pretreatment liquid volatilizes, the volatile component is less likely to reach the inside of the nozzles of the head 30 facing the printing medium.

Next, when the printing on the printing medium based on the print data is completed (printing processing is completed), the controller 80 controls the humidifier 66 to stop the supply of the humidified air from the two humidified air supply ports 61A and 62A (S4). That is, the controller 80 stops the driving of the humidifying drive unit 661 to stop the generation of the humidified air. Then, the driving of the fans 662 and 663 is also stopped, and the supply of the humidified air from the two humidified air supply ports 61A and 62A is stopped.

Thereafter, as illustrated in FIG. 11B, the controller 80 controls the sub scanning motor 26 based on a detection result from the encoder 261 to stop the platen 12 at the set position P1. The user removes the printing medium on which the image is formed from the platen 12 disposed at the set position P1. In this case, the controller 80 controls the main scanning motor 99 based on a detection result from the encoder 991 to move the carriage 6 leftward from the ejection region B2 and stop the carriage 6 at the maintenance position B1.

The controller 80 starts driving of the fans 94 of the suction mechanisms 73 and 74 when the printing on the printing medium based on the print data is completed, that is, when a color ink ejection period during which the color ink is ejected onto the printing medium ends (S5). Accordingly, air flows flow from the printing conveyance region P3, the ejection region B2, and spaces in the vicinity of these regions to the suction ports 713 and 723 are formed. As a result, foreign matter such as ink mist and dust in the air can be adsorbed and collected by the filter unit 18. Since the suction mechanisms 73 and 74 are driven after the color ink ejection period ends, it is possible to prevent disturbance of landing accuracy of the ink to the printing medium due to airflows generated by driving the suction mechanisms 73 and 74. The controller 80 stops the driving of the fans 94 of the suction mechanisms 73 and 74 after a predetermined time has elapsed.

Next, the controller 80 determines whether humidity detected by the humidity sensor 90 exceeds a first threshold value (S6). In the present embodiment, S6 is executed after S5, but S6 may be executed before S5. That is, in the printing processing, the controller 80 may execute S6 when an ejection period during which the ink is ejected from the head 30, that is, a printing period ends. The first threshold value (an example of a “first threshold”) is stored in the flash memory 80D. The first threshold value is humidity of a boundary value at which dew condensation is likely to occur in the housing 8 in a state where the driving of the humidifying mechanism 60 is stopped. The first threshold value in the present embodiment is, for example, 70%, but may be appropriately changed according to a surrounding environment. In a case where the humidity is equal to or lower than the first threshold value (NO in S6), the controller 80 determines that the humidity inside the housing 8 is low, the fans 96 and 97 of the air blowing mechanism 95 are not driven, and the flow for printing ends.

On the other hand, when the controller 80 receives, from the humidity sensor 90, a signal (an example of a “first signal”) indicating that the humidity inside the housing 8 exceeds the first threshold value, that is, in a case where the humidity exceeds the first threshold value (YES in S6), the controller 80 starts driving of the fans 95A and 95B of the air blowing mechanism 95 (S7). As a result, as illustrated in FIG. 11B, the two fans 95A and 95B generate an air flow 95C (indicated by a white arrow in the drawing) from the rear toward the front inside the housing 8. That is, the air blowing mechanism 95 supplies the dehumidified air inside the chamber 40 into the housing 8 through the second openings 85 and 86, blows high-humidity air inside the housing 8 from the rear toward the front, and discharges the air to the outside through the platen opening 13. Therefore, the humidity inside the housing 8 is effectively reduced.

The controller 80 determines whether a first predetermined time has elapsed after starting the driving of the fans 95A and 95B (S8). In a case where the first predetermined time has not elapsed (NO in S8), S8 is repeated. The first predetermined time is set to be a period of time until the humidity inside the housing 8 becomes equal to or lower than the first threshold value even when the humidity exceeds the first threshold value by driving the air blowing mechanism 95. On the other hand, in a case where the first predetermined time has elapsed (YES in S8), the controller 80 stops the driving of the fans 95A and 95B of the air blowing mechanism 95 (S9). In this manner, the flow for printing ends.

In a modification, instead of S8, the controller 80 determines whether the humidity detected by the humidity sensor 90 is equal to or lower than a second threshold value that is equal to or lower than the first threshold value. When the controller 80 receives, from the humidity sensor 90, a signal (an example of a “second signal”) indicating that the humidity inside the housing 8 is equal to or lower than the second threshold value, that is, in a case where the humidity is equal to or lower than the second threshold value, the controller 80 may stop the driving of the fans 95A and 95B of the air blowing mechanism 95. On the other hand, in a case where the humidity exceeds the second threshold value, the process may be repeated. The second threshold value (an example of a “second threshold”) in the modification is, for example, 60%, but may be appropriately changed as long as the second threshold value is equal to or lower than the first threshold value. The second threshold value may be the same as the first threshold value.

As another modification, the controller 80 may execute the process of S5 after the process of S9 is executed. That is, S5 may be executed after the humidity detected by the humidity sensor 90 becomes equal to or lower than the first threshold value.

### <Dehumidifying Control>

With reference to FIG. 12, control by the controller 80 when the inside of the housing 8 is dehumidified will be described. When a power supply of the printing device 1 is turned on, the controller 80 reads the control program from the ROM 80B and operates to execute a flow of FIG. 12. Hereinafter, the flow of FIG. 12 will be described. In the present embodiment, the controller 80 directly executes driving control of the dehumidifier 47, but the controller 80 and a controller (not illustrated) of the dehumidifier 47 may be connected via an interface (not illustrated). The controller of the dehumidifier 47 may drive and control the dehumidifier 47 based on a control instruction from the controller 80.

First, the controller 80 determines whether the humidity detected by the humidity sensor 90 exceeds the first threshold value (S21), as in S6 described above. In a case where the humidity is equal to or lower than the first threshold value (NO in S21), the controller 80 repeats S21.

On the other hand, when the controller 80 receives a signal indicating that the humidity inside the housing 8 exceeds the first threshold value from the humidity sensor 90, that is, in a case where the humidity exceeds the first threshold value (YES in S21), the controller 80 starts driving of the dehumidifier 47 (S22). In this manner, the air inside the chamber 40 is turned into dehumidified air.

Next, the controller 80 starts driving of the fans 96A and 96B of the air blowing mechanism 96 (S23). Accordingly, as illustrated in FIG. 11B, an air flow 96C (indicated by a white arrow of a two-dot chain line in the drawing) from the rear toward the front is generated by the two fans 96A and 96B inside the housing 8. That is, the air blowing mechanism 96 supplies the dehumidified air inside the chamber 40 into the housing 8 through the first openings 82 and 83, blows the high-humidity air inside the housing 8 from the rear toward the front, and discharges the air to the outside through the platen opening 13. Therefore, the humidity inside the housing 8 is effectively reduced. Further, when the air blowing mechanism 96 is driven, the dehumidified air inside the chamber 40 is also supplied from the first openings 81 and 84 into the housing 8.

The first openings 82 and 83 are located higher than the nozzle surfaces 311, 321, 331, and 341. Therefore, even when the air flow 96C is generated, it is possible to prevent the dehumidified air from directly hitting the nozzle surfaces 311, 321, 331, and 341. Therefore, it is possible to prevent an increase in viscosity of the ink in the vicinity of the nozzles 313, 323, 333, and 343 by drying. Further, since the air flow 96C is generated on an upper side than the nozzle surfaces 311, 321, 331, and 341, even when the air blowing mechanism 96 is driven during the printing period, it is possible to prevent disturbance of the landing accuracy of the ink to the printing medium due to an airflow generated by the air flow 96C.

Next, the controller 80 determines whether the humidity detected by the humidity sensor 90 is equal to or lower than the second threshold value (S24). In a case where the humidity inside the housing 8 exceeds the second threshold value (NO in S24), S24 is repeated. On the other hand, when the controller 80 receives a signal indicating that the humidity inside the housing 8 is equal to or lower than the second threshold value from the humidity sensor 90, that is, in a case where the humidity is equal to or lower than the second threshold value (YES in S24), the controller 80 stops the driving of the fans 96A and 96B of the air blowing mechanism 96 and stops the driving of the dehumidifier 47 (S25). In this manner, the flow for the dehumidifying control ends.

As a modification, the dehumidifier 47 may be driven until the power supply of the printing device 1 is turned off after the power supply is turned on. In addition, the dehumidifier 47 may be periodically driven at predetermined intervals while the power supply of the printing device 1 is on. Further, the dehumidifier 47 may be driven and stopped by manual operations of the user. In this case, the controller 80 omits drive and stop processes of the dehumidifier 47 in S22 and S25 from the flow of FIG. 12.

As another modification, the dehumidifier 47 may automatically dehumidify the air inside the chamber 40 while the power supply is on. In control in this case, the controller of the dehumidifier 47 drives the dehumidifier 47 in a case where the humidity detected by the humidity sensor built in the dehumidifier 47 is equal to or higher than a predetermined value, and stops the driving of the dehumidifier 47 in a case where the humidity is lower than the predetermined value. In this manner, the humidity of the air inside the chamber 40 is maintained at a value that is equal to or lower than the predetermined value. In such a modification, the flow for the dehumidifying control by the controller 80 is the same as that of the above-described embodiment except that the drive and stop processes of the dehumidifier 47 in S22 and S25 are omitted. In this manner, the drive control of the dehumidifier 47 and the drive control of the fans 96A and 96B of the air blowing mechanism 96 may be separately executed.

As described above, according to the printing device 1 of the present embodiment, the first openings 81 to 84 and the second openings 85 and 86 that communicate with the chamber 40 are formed in the housing 8. Therefore, the dehumidified air accommodated in the chamber 40 is supplied into the housing 8 through the first openings 81 to 84 and the second openings 85 and 86. Therefore, regardless of the use environment, the humidity inside the housing 8 can be reduced.

In addition, according to the printing device 1 of the present embodiment, since the humidified air can be supplied to the inside of the housing 8, the volatile component of the pretreatment liquid applied to the printing medium is less likely to volatilize, and the volatile component of the pretreatment liquid itself is less likely to reach the nozzles of the head 30. Therefore, it is possible to prevent occurrence of a failure due to a reaction between the ink in the nozzles and the volatile component of the pretreatment liquid. In addition, by driving the air blowing mechanisms 95 and 96, the humidified air in the inside of the housing 8 supplied from the humidifying mechanism 60 can be discharged to the outside of the housing 8 and the dehumidified air inside the chamber 40 can be supplied into the housing 8. Therefore, it is possible to prevent occurrence of dew condensation in the inside of the housing 8. For example, when dew condensation occurs on the encoders 261 and 991 and the like inside the housing 8, detection accuracy is reduced, and an operation failure of the printing device occurs, but in the present embodiment, since the occurrence of dew condensation inside the housing 8 can be prevented, the occurrence of an operation failure in the printing device 1 can be prevented.

The air blowing mechanisms 95 and 96 generate airflows such that the dehumidified air inside the chamber 40 is supplied into the housing 8 through the first openings 81 to 84 and the second openings 85 and 86. As a result, it is possible to effectively supply the dehumidified air into the housing 8.

The fans 95A and 95B are provided in the second openings 85 and 86, and the fans 96A and 96B are provided in the first openings 82 and 83. Accordingly, when the fans 95A, 95B, 96A, and 96B are driven, it is possible to forcibly supply the dehumidified air inside the chamber 40 into the housing 8. Therefore, it is possible to more effectively supply the dehumidified air into the housing 8.

As a modification, the fans 96A and 96B of the air blowing mechanism 96 may be provided at a position (for example, a position in the vicinity of the platen opening 13) where the air inside the housing 8 can be forcibly discharged from the platen opening 13 to the outside. In this case, when the fans 96A and 96B are driven, the air inside the housing 8 is discharged to the outside, resulting in a negative pressure inside the housing 8. Accordingly, the dehumidified air inside the chamber 40 is supplied into the housing 8 through the first openings 81 to 84 and the second openings 85 and 86. That is, the fans 96A and 96B may be capable of generating an airflow such that the dehumidified air inside the chamber 40 is supplied into the housing 8 through the first openings 81 to 84 and the second openings 85 and 86. As a result, it is possible to effectively supply the dehumidified air into the housing 8.

In the case of YES in S6, the controller 80 starts driving of the air blowing mechanism 95 to supply the dehumidified air inside the chamber 40 from the second openings 85 and 86 into the housing 8. In addition, in the case of YES in S21, the controller 80 starts driving of the air blowing mechanism 96 to supply the dehumidified air inside the chamber 40 from the first openings 81 to 84 into the housing 8. As a result, when the humidity inside the housing 8 exceeds the first threshold value, it is possible to efficiently reduce the humidity.

In the case of YES in S24, the controller 80 stops the driving of the air blowing mechanism 96 to stop the dehumidified air inside the chamber 40 from being forcibly supplied from the first openings 81 to 84 into the housing 8. As a result, it is possible to effectively prevent the humidity inside the housing 8 from being reduced more than necessary. Therefore, it is possible to prevent an increase in viscosity of the ink in the nozzles 313, 323, 333, and 343 by drying.

As a modification, when the humidity inside the housing 8 exceeds the first threshold value, the user may operate the operation unit 15 to output a supply start command of the dehumidified air to the controller 80. In this case, the controller 80 executes the processes of S22 and S23 when the supply start command (an example of a “first signal”) is received. Also in this case, the same effects as those of the above-described embodiment can be obtained. In addition, the humidity sensor 90 may not be provided. Thereafter, when the humidity inside the housing 8 is equal to or lower than the second threshold value, the user may operate the operation unit 15 to output the supply stop command of the dehumidified air to the controller 80. In this case, the controller 80 executes the process of S25 when the supply stop command (an example of a “second signal”) is received. Also in this case, the same effects as those of the above-described embodiment can be obtained.

As another modification, a door capable of opening and closing at least any first opening among the first openings 81 to 84 may be provided in the housing 8. In addition, a door state output unit may be provided in which an open signal is output to the controller 80 when the first opening is switched from a close state to an open state and a close signal is output to the controller 80 when the first opening is switched from the open state to the close state, by the user manually operating the door. The user may manually operate the door to output the open signal from the door state output unit to the controller 80 when the humidity inside the housing 8 exceeds the first threshold value. In this case, the controller 80 executes the processes of S22 and S23 when the open signal (an example of a “first signal”) is received. Also in this case, the same effects as those of the above-described embodiment can be obtained. In addition, the humidity sensor 90 may not be provided. Thereafter, the user may manually operate the door to output the close signal from the door state output unit to the controller 80 when the humidity inside the housing 8 is equal to or lower than the second threshold value. In this case, the controller 80 executes the process of S25 when the close signal (an example of a “second signal”) is received. Also in this case, the same effects as those of the above-described embodiment can be obtained.

Further, as another modification, a door capable of opening and closing at least any first opening among the first openings 81 to 84 may be provided in the housing 8. In addition, a door drive unit that drives opening and closing of the door may be provided under control of the controller 80. In this case, when executing S23, the controller 80 may control the door drive unit such that the first opening is switched from the close state to the open state instead of the fans 96A and 96B. Accordingly, the dehumidified air inside the chamber 40 is supplied into the housing 8 through the first opening in the open state. Also in this case, the same effects as those of the above-described embodiment can be obtained. In addition, the air blowing mechanism 96 may not be provided. Further, when executing S25, the controller 80 may control the door drive unit such that the first opening is switched from the open state to the close state instead of the fans 96A and 96B. As a result, as in the above-described embodiment, it is possible to effectively prevent the humidity inside the housing 8 from being reduced more than necessary.

As another modification, the controller 80 may execute only S22 and may not execute S23. Also in this case, the first openings 81 to 84 and the second openings 85 and 86 that communicate with the chamber 40 are formed in the housing 8. Therefore, the dehumidified air accommodated in the chamber 40 is supplied into the housing 8 through the first openings 81 to 84 and the second openings 85 and 86. Therefore, regardless of the use environment, the humidity inside the housing 8 can be reduced. In addition, the air blowing mechanism 96 may not be provided. Further, when executing S25, the controller 80 may stop the driving of the dehumidifier 47. As a result, as in the above-described embodiment, it is possible to effectively prevent the humidity inside the housing 8 from being reduced more than necessary.

In addition to the first openings 81 to 84, the second openings 85 and 86 are provided in the housing 8. As a result, it is possible to effectively reduce the humidity inside the housing 8.

In the present embodiment, the driving of the air blowing mechanism 95 is stopped during the printing period of the printing processing. As a result, the dehumidified air supplied into the housing 8 through the second openings 85 and 86 does not hit the nozzle surfaces 311, 321, 331, and 341 during the printing period. Therefore, an ejection direction of the ink is stabilized.

The first openings 81 to 84 are formed in the rear surface 8B of the housing 8, and the platen opening 13 is formed in the front surface 8A of the housing. As a result, high-humidity air inside the housing 8 is discharged to the outside through the platen opening 13, and the dehumidified air is supplied into the housing 8 through the first openings 81 to 84 on an opposite side of the platen opening 13. Therefore, it is possible to effectively reduce the humidity inside the housing 8.

The chamber 40 is disposed adjacent to the rear surface 8B of the housing 8. As a result, it is possible to reduce a size of the printing device 1 in the left-right direction.

The air blowing mechanism 96 is located on the side opposite to the head 30 from the platen opening 13 in the front-rear direction. This makes it easier for the air blowing mechanism 96 to discharge the dehumidified air inside the housing 8 to the outside through the platen opening 13. In addition, the dehumidified air is supplied into the housing 8 through the first openings 81 to 84 located on the opposite side of the platen opening 13. Therefore, it is possible to effectively reduce the humidity inside the housing 8.

### Second Embodiment

A printing device 201 according to the second embodiment of the present disclosure will be described with reference to FIG. 13. The printing device 201 according to the present embodiment is the same as the printing device 1 according to the first embodiment except that an installation position of the chamber 40, formation positions of two openings 282 and 283 provided instead of the first openings 81 to 84, and installation positions of the fans 96A and 96B of the air blowing mechanism 96 are different from those of the above-described printing device 1 according to the first embodiment. The same components as those of the first embodiment are denoted by the same reference numerals, and the description thereof is omitted.

The chamber 40 in the present embodiment is disposed adjacent to a left surface (an example of a “surface in a second direction”) 8C on a left side of the housing 8. The chamber 40 includes the frame body 41 and the sheet 42, and has a space therein for accommodating the dehumidified air. The sheet 42 is disposed so as to cover an upper side, front and rear lateral sides, and an entire left side of the frame body 41. The dehumidifier 47 and the dehumidifying tank 48 are disposed inside the chamber 40.

The two openings 282 and 283 are formed in the left surface 8C of the housing 8. The openings 282 and 283 penetrate the outer peripheral panel 9 in the thickness direction thereof, and allow the inside of the housing 8 and the outside of the housing 8 (inside of the chamber 40) to communicate with each other.

The openings 282 and 283 are disposed backward of the head 30 and higher than the nozzle surfaces 311, 321, 331, and 341 in the front-rear direction. In addition, the openings 282 and 283 are disposed to be separated from each other along the front-rear direction.

The fans 96A and 96B of the air blowing mechanism 96 are fixed to the outer peripheral panel 9 constituting the left surface 8C of the housing 8. More specifically, the fan 96A is provided in the opening 282, and the fan 96B is provided in the opening 283. The fan 96A covers the opening 282, and the fan 96B covers the opening 283. In a case where the two fans 96A and 96B are driven, air in the outside flows from the left side to the rear portion inside the housing 8. That is, the air blowing mechanism 96 according to the present embodiment supplies the air in the outside (inside the chamber 40) of the housing 8 to the rear portion inside the housing 8 through the two openings 282 and 283. As a result, the air inside the housing 8 flows from the rear toward the front and is discharged to the outside through the platen opening 13. Since the two fans 96A and 96B are disposed at positions not overlapping with the head 30 in the left-right direction and higher than the nozzle surfaces 311, 321, 331, and 341, the air supplied into the housing 8 by driving the fans 96A and 96B does not directly hit the nozzle surfaces 311, 321, 331, and 341. Therefore, the same effect as that of the first embodiment described above can be obtained.

Also in the printing device 201, the controller 80 executes the same dehumidifying control (refer to S21 to S23 in FIG. 12) as that of the first embodiment described above, so that the dehumidified air inside the chamber 40 can be supplied into the housing 8 through the openings 282 and 283, and the high-humidity air inside the housing 8 can be caused to flow from the rear toward the front to be discharged to the outside through the platen opening 13. Therefore, the humidity inside the housing 8 is effectively reduced. Next, the controller 80 executes S24 and S25 to end the flow for the dehumidifying control.

As described above, according to the printing device 201 of the present embodiment, the openings 282 and 283 that communicate with the chamber 40 are formed in the housing 8. Therefore, the dehumidified air accommodated in the chamber 40 is supplied into the housing 8 through the openings 282 and 283. Therefore, regardless of the use environment, the humidity inside the housing 8 can be reduced. The same effect can be obtained in the same configuration as that of the first embodiment described above.

The chamber 40 is disposed adjacent to the left surface 8C of the housing 8. As a result, it is possible to reduce a size of the printing device 201 in the front-rear direction.

In the second embodiment described above, the openings 282 and 283 are formed in the left surface 8C, but the openings 282 and 283 may be disposed at positions that do not overlap the head 30 (nozzle surfaces 311, 321, 331, and 341) in the left-right direction on a right surface (an example of a “surface in the second direction”) 8D.

Although a preferred embodiment of the present disclosure has been described above, the present disclosure is not limited to the embodiment described above, and various modifications can be made within the scope of the claims.

In each of the embodiments and each of the modifications described above, the air blowing mechanisms 95 and 96 (fans 95A, 95B, 96A, and 96B) are provided, but at least any of the air blowing mechanisms 95 and 96 may not be provided.

At least any of the first openings 81 to 84 and the second openings 85 and 86 may be formed in the housing 8. In addition, seven or more openings other than the platen opening 13 may be formed in the housing 8. Further, the openings other than the platen opening 13 (opening through which the dehumidified air inside the chamber 40 is supplied into the housing 8) may be formed in at least any of the upper surface 8E, the lower surface 8F, and the front surface 8A of the housing 8. In this case, a pipe that communicates with the inside of the chamber 40 may be connected to the openings, or the chamber 40 may be provided adjacent to the surface in which the openings are formed and the chamber 40 and the housing 8 may communicate with each other through the openings. In short, an opening for supplying the dehumidified air inside the chamber 40 into the housing 8 may be formed in any part of the housing 8. Accordingly, the same effects as those of the above-described embodiment can be obtained.

The fan of the air blowing mechanism 96 may be provided in the opening (opening through which the dehumidified air inside the chamber 40 is supplied into the housing 8) formed in the housing 8. In addition, the air blowing mechanism 96 may include one or three or more fans. Further, the air sent by the air blowing mechanism 96 may be discharged from the inside of the housing 8 to the outside through the openings other than the platen opening 13. The air blowing mechanism 96 is provided behind the housing 8, but the air blowing mechanism may be provided at any position of the housing 8 as long as the air can be blown from the inside of the housing 8 toward the outside.

In each of the embodiments and each of the modifications described above, the dehumidified air generated by the dehumidifier 47 is accommodated in the chamber 40, but the dehumidifier 47 may be provided outside the chamber 40, and the dehumidified air generated by the dehumidifier 47 may be supplied to the chamber 40 outside and stored in the chamber 40. In addition, the dehumidifier 47 may be any of a small-sized machine for home use, a large-sized machine for business use or factory use, and the like, and is not particularly limited. Further, the dehumidified air may be supplied into the chamber 40 from an air line that is installed in a factory or the like and to which the dehumidified air is supplied.

In the embodiments and each of the modifications described above, S23 is executed after S22, but S22 may be executed after S23. In S25, the driving of the dehumidifier 47 may not be stopped.

Between the white heads 31 and 32 and the color heads 33 and 34 of the carriage 6, an overcoating head that ejects a post-treatment liquid for overcoating an image formed on the printing medium may be provided. In this case, after the ejection of the color ink onto the printing medium is completed and the image is formed (after the printing processing is completed), the platen 12 is returned to the pre-printing standby position P2 again. Then, the platen 12 is conveyed to the printing conveyance region P3, and the post-treatment liquid is discharged from the overcoating head to the printing medium. In this manner, the image on the printing medium can be overcoated. Also in such a printing device, as in the case of the embodiments and each of the modifications described above, the air blowing mechanism 95 is driven in S7 after the printing processing in which the discharge of the color ink is completed, and thus dew condensation is less likely to occur inside the housing 8.

In the embodiments described above, the humidified air sent from the humidifier 66 to the supply ports 75 and 76 is sent to the two humidified air supply pipes 61 and 62, but the humidified air sent to the supply ports 75 and 76 may be directly supplied into the housing 8 from the supply ports 75 and 76. That is, the two humidified air supply pipes 61 and 62 may not be provided. Also in this case, by humidifying the inside of the housing 8, the volatile component of the pretreatment liquid applied to the printing medium is less likely to volatilize. Therefore, it is possible to prevent occurrence of a failure due to a reaction between the ink in the nozzle and the volatile component of the pretreatment liquid. Also in this case, by executing S7 described above, it is possible to discharge the humidified air inside the housing 8 to the outside of the housing 8. Therefore, it is possible to prevent occurrence of dew condensation in the inside of the housing 8. By connecting the humidifier 66 and the two humidified air supply pipes 61 and 62 in a separate path, the humidified air may be supplied from the two humidified air supply pipes 61 and 62 as described above. In addition, by providing a humidifier different from the humidifier 66 and connecting the different humidifier and the two humidified air supply pipes 61 and 62 via a piping member such as a tube, the humidified air may be supplied from the supply ports 75 and 76 and the two humidified air supply pipes 61 and 62. This makes it easier to effectively form the humidified air layer on the printing medium. Therefore, the volatile component of the pretreatment liquid applied to the printing medium is further less likely to volatilize. Even when the volatile component of the pretreatment liquid volatilizes, the volatile component is much less likely to reach the inside of the nozzles of the head 30 facing the printing medium. In any of such modifications, the humidifier 66 may be controlled in the same manner as in the embodiments and each of the modifications described above. The humidifying mechanism 60 may have any configuration as long as the humidified air can be supplied to the inside of the housing 8.

In the embodiments described above, the humidity sensor 90 is disposed on the left side of the platen opening 13, but a plurality of humidity sensors 90 may be provided inside the housing 8. In this case, when any of the humidity sensors 90 detects the humidity exceeding the first threshold value, the processes of S22 and thereafter may be executed. The humidity sensor 90 may not be provided, and the processes of S6, S21, and S24 may not be executed. In this case, S7, S22, S23, and S25 may be appropriately executed after S2 is executed. Also in this case, it is possible to reduce the humidity inside the housing 8, and dew condensation is less likely to occur inside the housing 8.

The heads 30 in the embodiments and each of the modifications described above have been described as an example in which the present disclosure is applied to a printing device including a so-called serial head that ejects ink from a plurality of nozzles while moving along the main scanning direction (left-right direction) by the moving mechanism 77, but the present disclosure is not limited thereto. For example, the present disclosure can also be applied to a printing device provided with a line head extending over the entire length of the printing medium (platen 12) in the main scanning direction and disposed so as not to be movable in the ejection region B2.

The printing device according to the embodiments and each of the modifications described above may include a pretreatment liquid application mechanism for applying the pretreatment liquid to the printing medium. The pretreatment liquid application mechanism may be provided, for example, at a position where the pretreatment liquid can be applied to the printing medium (front surface 8A of the housing 8) until the printing medium is conveyed from the set position P1 to the printing conveyance region P3. The pretreatment liquid may be applied to the printing medium by the pretreatment liquid application mechanism before the printing processing is executed. In S1 described above, after the printing start command is input, the pretreatment liquid may be applied to the printing medium by the pretreatment liquid application mechanism.

In addition, in the controller 80 in the embodiments and each of the modifications described above, a microcomputer, application specific integrated circuits (ASIC), a field programmable gate array (FPGA), or the like may be used as a processor instead of the CPU 80A. In this case, a main process may be distributed and executed by a plurality of processors. A non-transitory storage medium such as the ROM 80B and the flash memory 80D may be any storage medium capable of storing information regardless of a period during which the information is stored. The non-transitory storage medium may not include a temporary storage medium (for example, a transmitted signal). For example, the control program may be downloaded (that is, transmitted as a transmission signal) from a server connected to a network (not illustrated) and stored in the ROM 80B or the flash memory 80D. In this case, the control program may be stored in a non-transitory storage medium such as an HDD provided in the server. In the embodiments and each of the modifications described above, the volatile component of the pretreatment liquid contains an organic acid, but the present disclosure is not limited thereto. That is, the volatile component of the pretreatment liquid may include a component other than the organic acid, which reacts with the ink in the nozzle to cause aggregation or discoloration.

What is claimed is:

1. A printing device comprising:
a head configured to eject ink;
a housing in which the head is disposed; and
a chamber provided outside the housing and configured to accommodate dehumidified air generated by a dehumidifier,
wherein the housing has at least one opening communicating with the chamber.

2. The printing device according to claim 1, further comprising:
an air blower configured to generate an airflow such that the dehumidified air in the chamber is supplied into the housing through the at least one opening.

3. The printing device according to claim 2,
wherein the air blower is provided in the at least one opening.

4. The printing device according to claim 1, further comprising:
a controller,
wherein the controller is configured to perform control to cause the dehumidified air in the chamber to be supplied into the housing through the at least one opening in response to receiving a first signal indicating that humidity inside the housing exceeds a first threshold.

5. The printing device according to claim 4,
wherein the controller is configured to perform control to cause a supply of the dehumidified air into the housing to stop in response to receiving a second signal indicating that the humidity inside the housing is a second threshold or less, the second threshold being the first threshold or less.

6. The printing device according to claim 4, further comprising:
an air blower configured to generate an airflow such that the dehumidified air in the chamber is supplied into the housing through the at least one opening,
wherein the controller is configured to drive the air blower in response to receiving the first signal.

7. The printing device according to claim 5, further comprising:
an air blower configured to generate an airflow such that the dehumidified air in the chamber is supplied into the housing through the at least one opening,
wherein the controller is configured to stop driving of the air blower in response to receiving the second signal.

8. The printing device according to claim 1,
wherein the head comprises a nozzle surface on which a nozzle configured to eject ink is formed, and
wherein the at least one opening comprises a first opening located higher than the nozzle surface.

9. The printing device according to claim 8,
wherein the at least one opening further comprises a second opening located lower than the nozzle surface.

10. The printing device according to claim 9, further comprising:
a first air blower provided in the first opening;
a second air blower provided in the second opening; and
a controller,
wherein the controller is configured to stop driving of the second air blower in a printing period during which ink is ejected from the head to a printing medium.

11. The printing device according to claim 8, further comprising:
a support portion configured to move in a first direction between an inside of the housing and an outside of the housing and configured to support a printing medium,
wherein a passing port through which the support portion passes is formed on one surface of the housing in the first direction, and
wherein the first opening is formed on another surface of the housing in the first direction.

12. The printing device according to claim 1, further comprising:
a support portion configured to move in a first direction between an inside of the housing and an outside of the housing and configured to support a printing medium,
wherein the head comprises a nozzle surface on which a nozzle configured to eject ink is formed, and
wherein the at least one opening is formed on a surface of the housing in a second direction intersecting the first direction at a position not overlapping the nozzle surface in the second direction.

13. The printing device according to claim 1, further comprising:
a support portion configured to move in a first direction between an inside of the housing and an outside of the housing and configured to support a printing medium,
wherein a passing port through which the support portion passes is formed on one surface of the housing in the first direction, and
wherein the chamber is disposed adjacent to another surface of the housing in the first direction.

14. The printing device according to claim 1, further comprising:
a support portion configured to move in a first direction between an inside of the housing and an outside of the housing and configured to support a printing medium,
wherein the chamber is disposed adjacent to a surface of the housing in a second direction intersecting the first direction.

15. The printing device according to claim 1, further comprising:
a support portion configured to move in a first direction between an inside of the housing and an outside of the housing and configured to support a printing medium; and
an air blower,
wherein a passing port through which the support portion passes is formed on one surface of the housing in the first direction,
wherein the air blower is configured to generate an airflow in a direction from the inside of the housing to the outside of the housing through the passing port,
wherein the at least one opening is formed on another surface of the housing in the first direction, and
wherein the air blower is located on a side opposite to the passing port with respect to the head in the first direction.

16. The printing device according to claim 1,
wherein the housing further has a humidified air supply port to which humidified air is supplied, and
wherein the printing device further comprises:
a dehumidifying tank configured to store water generated when the dehumidified air accommodated in the chamber is generated;
a humidifying tank configured to store water for generating humidified air to be supplied to the humidified air supply port; and
a communication flow path configured to allow the dehumidifying tank to communicate with the humidifying tank.
